(19) United States
(12) Patent Application Publication
(10) Pub. No.: US 2019/0043526 A1
(43) Pub. Date: Feb. 7, 2019

(54) STRESS MANAGEMENT THROUGH VOICE DATA ANALYSIS

(71) Applicant: HEWLETT-PACKARD DEVELOPMENT COMPANY, L.P., Houston, TX (US)

(72) Inventors: Natan FACCHIN, Rio Grande do Sul (BR); Lucas LIMA DE ARAUJO, Rio Grande do Sul (BR); Pedro Henrique GARCEZ MONTEIRO, Rio Grande do Sul (BR)

(73) Assignee: HEWLETT-PACKARD DEVELOPMENT COMPANY, L.P., Houston, TX (US)

(21) Appl. No.: 16/076,515

(22) PCT Filed: Jan. 18, 2017
(86) PCT No.: PCT/US17/13897

§ 371 Date: Aug. 8, 2018

(51) Int. Cl. G10L 25/63; G06F 11/34

(52) U.S. Cl. CPC G10L 25/63; G06F 11/3438

(57) ABSTRACT

An example mobile system is disclosed. The system comprises an audio input device to continuously capture audio data associated with a user, a display unit, a processor, connected to the audio unit and the display unit, to detect stress data based on the audio data associated with the user over a period of time, measure a change in the stress data over the period of time, determine usage data on the mobile system by the user over the period of time, perform an analysis of the change in the stress data in view of the usage data, and propose an action to manage the change in the stress data based on the analysis.

### BACKGROUND

Physiological or biological stress is an organism's response to a stressor such as an environmental condition. Stress is a body's method of reacting to a challenge. Voice risk or voice stress analysis (VSA) technology records psychophysiological stress responses that are present in the human voice when a person suffers psychological stress in response to a stimulus (e.g., a question).

### BRIEF DESCRIPTION OF THE DRAWINGS

Examples are described in the following detailed description and in reference to the drawings, in which:

FIG. 1 illustrates a schematic representation of an example device in accordance with an implementation of the present disclosure; and

FIG. 2 illustrates an example process flow diagram in accordance with an implementation.

### DETAILED DESCRIPTION

Various aspects of the present disclosure are directed to a mobile device to measure and manage stress. More specifically, and as described in greater detail below, various aspects of the present disclosure are directed to a manner by which a mobile device can be used to measure stress level of a user of the mobile device and determine ways to manage such stress based on usage data associated with the device and specific applications on the device.

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to. . . . ” Also, the term “couple” or “couples” is intended to mean either an indirect or direct connection. Thus, if a first device couples to a second device, that connection may be through a direct electrical or mechanical connection, through an indirect electrical or mechanical connection via other devices and connections, through an optical electrical connection, or through a wireless electrical connection. As used herein the term “approximately” means plus or minus 10%. In addition, as used herein, the phrase “user input device” refers to any suitable device for providing an input, by a user, into an electrical system such as, for example, a mouse, keyboard, a hand (or any finger thereof), a stylus, a pointing device, etc.

The following discussion is directed to various examples of the disclosure. Although one or more of these examples may be preferred, the examples disclosed should not be interpreted, or otherwise used, as limiting the scope of the disclosure, including the claims. In addition, one skilled in the art will understand that the following description has broad application, and the discussion of any example is meant only to be descriptive of that example, and not intended to intimate that the scope of the disclosure, including the claims, is limited to that example.

Aspects of the present disclosure described herein disclose detecting a change in the stress level of a person by collecting audio data associated with the person. Among other things, this approach allows an accurate observation of the stress level of a user since the change in audio data is a strong indication of the person's stress level. In other implementations consistent with the invention discussed herein, additional source data may be utilized to analyze the stress level of a user. For example, in addition to or in place of the audio data, visual data of muscle activity of the user may be utilized. Moreover, other aspects of the present disclosure described herein disclose analyzing the change in the stress level of a person based on that person's use of various applications. Among other things, this approach allows to observe how a person's use of different applications affect the person's stress level, and provides a tool to propose actions to manage the change in the stress level.

In one example in accordance with the present disclosure, a method for managing stress is provided. The method comprises detecting stress data based on the audio data associated with the user over a period of time, measuring a change in the stress data over the period of time, determining usage data on the mobile system by the user over the period of time, performing an analysis of the change in the stress data in view of the usage data, and proposing an action to manage the change in the stress data based on the analysis.

In another example in accordance with the present disclosure, a mobile system is provided. The system comprises an audio input device to continuously capture audio data associated with a user, a display unit, and a processor, connected to the audio unit and the display unit. The processor detects stress data based on the audio data associated with the user over a period of time, measures a change in the stress data over the period of time, determines usage data on the mobile system by the user over the period of time, performs an analysis of the change in the stress data in view of the usage data, and proposes an action to manage the change in the stress data based on the analysis

In a further example in accordance with the present disclosure, a non-transitory computer readable medium is provided. The non-transitory computer-readable medium comprises instructions which, when executed, cause a mobile device to (i) detect stress data based on the audio data associated with the user over a period of time, (ii) measure a change in the stress data over the period of time, (iii) determine usage data on the mobile system by the user over the period of time, (iv) perform an analysis of the change in the stress data in view of the usage data, and (v) propose an action to manage the change in the stress data based on the combination.

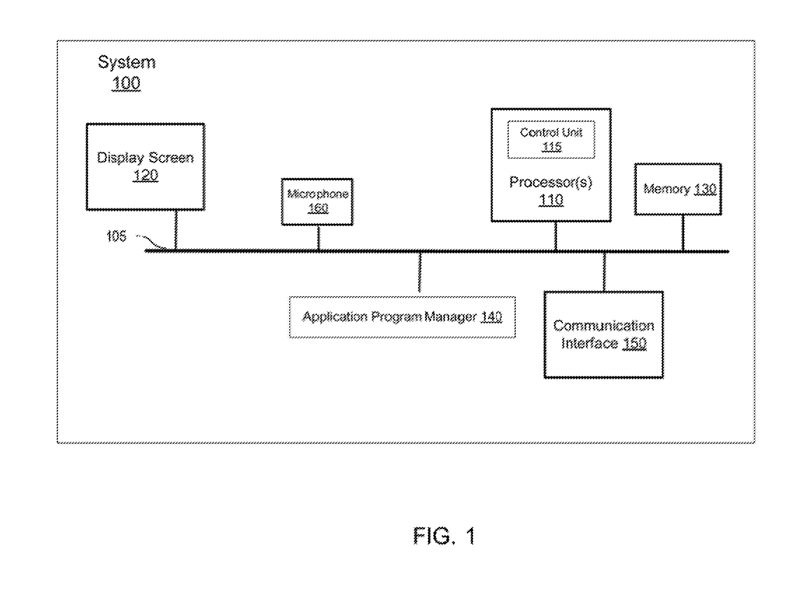

FIG. 1 is a schematic representation of an example system 100 for managing stress level for a user through an analysis of voice signal of the user. In the present example, the system 100 is a mobile device. In various examples, the system 100 may be a mobile terminal, and may be implemented in various other forms, such as a smartphone, portable laptop computer, wearable device such as a smartwatch, etc. It should be readily apparent that the present illustration should not be interpreted to be limited by this particular illustrative architecture shown in FIG. 1, and the display unit 120 represents a generalized illustration and that other elements may be added or the illustrated elements may be removed, modified, or rearranged in many ways.

The system 100 includes a processor 110 (e.g., a central processing unit, a microprocessor, a microcontroller, or another suitable programmable device), a display screen 120, a memory unit 130, an application manager 140, a communication interface 150, and a microphone 160. Each of these components or any additional components of the display unit 100 is operatively coupled to a bus 106. The bus 106 may be any of several types of bus structures including a memory bus or memory controller, a peripheral bus, and a local bus using any of a variety of bus architectures. In other examples, the display unit 100 includes additional, fewer, or different components for carrying out similar functionality described herein. In another implementation, the system 100 may also include a camera and/or a speaker.

The processor 110 includes a control unit 115 and may be implemented using any suitable type of processing system where at least one processor executes computer-readable instructions stored in the memory 130. The processor 110 may be, for example, a central processing unit (CPU), a semiconductor-based microprocessor, an application specific integrated circuit (ASIC), a field-programmable gate array (FPGA) configured to retrieve and execute instructions, other electro is circuitry suitable for the retrieval and execution instructions stored on a computer readable storage medium (e.g., the memory 130), or a combination thereof. The machine readable medium 130 may be a non-transitory computer-readable medium that stores machine readable instructions, codes, data, and/or other information. The instructions, when executed by processor 110 (e.g., via one processing element or multiple processing elements of the processor) can cause processor 110 to perform processes described herein.

Further, the computer readable medium 130 may participate in providing instructions to the processor 110 for execution. The machine readable medium 130 may be one or more of a non-volatile memory, a volatile memory, and/or one or more storage devices. Examples of non-volatile memory include, but are not limited to, electronically erasable programmable read only memory (EEPROM) and read only memory (ROM). Examples of volatile memory include, but are not limited to, static random access memory (SRAM) and dynamic random access memory (DRAM). Examples of storage devices include, but are not limited to, hard disk drives, compact disc drives, digital versatile disc drives, optical devices, and flash memory devices. As discussed in more detail above, the processor 110 may be in data communication with the machine readable medium 130, which may include a combination of temporary and/or permanent storage. The machine readable medium 130 may include program memory that includes all programs and software such as an operating system, user detection software component, and any other application software programs. The machine readable medium 130 may also include data memory that may include multicast group information, various table settings, and any other data required by any element of the ASIC.

The communication interface 150 enables the system 100 to communicate with a plurality of networks and communication links. In some examples, the communication interface of the system 100 may include a Wi-Fi® interface, a Bluetooth interface, a 3G interface, a 4G interface, a near riled communication (NEC) interface, and/or any other suitable interface that allows the computing device to communicate via one or more networks. The networks may include any suitable type or configuration of network to allow the system 100 to communicate with any external systems or devices.

The display screen 120 may be used to communicate with the user. In one implementation, a text or an image may be displayed on the display screen 120. The display screen 120 may be an organic light emitting diode (OLED) display, or any other suitable display. The display screen 120 may be a screen of a smart phone or a laptop. Further, the display screen 120 may be a flexible display that can be wrapped and unwrapped from around a bar. In such example, the display screen 120 may be a component of a tablet. An attachment section of the display screen 120 facilitates a coupling of flexible display to the bar in any conventional manner. In one implementation, the flexible display may have a magnetic disclosure, and the display wrapped around the bar may be held in place with the magnetic disclosure. Alternatively, a band may be used to hold the wrapped display around the bar. In another implementation, the screen may be wrapped around a part of a user's body (e.g., wrist, arm, leg). In such implementation, the display screen 120 may be a component of a wearable device, such as a smart watch. In various implementations, the flexible display screen 120 may have a variety of structural configuration and materiel composition. The display screen 120 is to display content from one or more applications communicated to the system 100. In one implementation, the display screen 120 comprises various display properties such as resolution, display pixel density, display orientation and/or display aspect ratio. The display screen 120 may be of different sizes and may support various types of display resolution, where display resolution is the number of distinct pixels in each dimension that can be displayed on the display screen 120. For example, the display screen 120 may support high display resolutions of 1920×1080, or any other suitable display resolutions. When the display screen supports a 1920×1080 display resolution, 1920 is the total number of pixels across the height of the display 120 and 1080 is the total number of pixels across the height of the display 120. In the current implementation, the display screen 120 may be used to display a proposed action based on the analysis of the change in stress data in view of the user's usage data of the mobile system 100.

In one implementation, the system ICC may comprise an audio unit. The system 100 may comprise a microphone or similar device that is arranged to receive sound inputs (e.g., voice) from the user during operation. In use, the system 100 includes a microphone 160, and the user speaks into the microphone 160. The microphone 160 Captures the user's voice and any detected background noise, which are then routed by the control unit 115 into the processor 110 for processing therein. In some implementations, the processor 110 requests data from the microphone 160 and thereafter performs an analysis to determine stress levels based on the audio data. Such analysis may include detection and measurement. In one implementation, the Hilbert-Huang Transform (HHT) may be used to perform an analysis of the audio data received from the microphone 160 to determine the stress level associated with the user. For example, when the frequency of the audio signal (e.g., the user's voice) increases or decreases, it can be concluded that the user's stress level is increasing or decreasing.

More specifically, HHT is an algorithm that can be applied to a data set, and is a transform function is a way to decompose a signal into intrinsic mode functions (IMF) along with a trend, and obtain instantaneous frequency data. The HHT uses the empirical mode decomposition (EMD) method to decompose a signal into intrinsic mode functions (IMF) with a trend, and applies the HSA method to the IMFs to obtain instantaneous frequency data. Since the signal is decomposed in time domain and the length of the IMFs is the same as the original signal, HHT preserves the characteristics of the varying frequency. In other examples, the same analysis method may be utilized to detect stress based on other types of muscle data, such as leg or eye. Such data may be captured using a different type of source, such as a camera. Further, the processor applies noise filtering to remove any noise in the audio data.

In one implementation, the system 100 may include a camera. The camera may be used to capture eye motion of the user. More specifically, as the stress level of a user changes, the user's eye motion also changes. To support this, the camera in the system 100 may be utilized. The camera may be used to capture the change in the eye motion and collect images of the user's eye gazing. Based on these images, data may be derived to analyze change in stress level of the user, and the system 100 may propose an action to manage the stress. When the system 100 determines an action to propose to the user, it is output via the display screen 120 (e.g., video or images) and a speaker (e.g., audio).

In an implementation with the speaker, the audio unit of the system 100 comprises an ambisonic sound system, providing three-dimensional (3D) sound in the environment. More specifically, the audio unit sends a sound signal with spatial information that enables the user to perceive the sound as originating from distinct spatial locations and different directions. In one example, the audio unit may target one user. That is, the audio unit may provide an effect of stereo sound when a single user is positioned within the direction of the speaker. In another example, the audio unit may provide a 3D sound for multiple users regardless of the users' positions.

The system 100 includes an application program manager 140. The application program manager 140 captures the user's usage data of applications associated with the system 100. Such data is then routed by the control unit 115 to the processor 110 for processing therein. For example, the application program manager 140 may provide data related to which applications the user uses, what type of activities the user performs in these applications, and how long the user uses these applications for. More specifically, the user may choose to open and use a social media application for 30 minutes. The user may type messages, open documents and load/download images in the duration that he is active on the application. The application program manager 140 captures such data and provides it to the processor for further processing. Moreover, the processor performs an analysis of the change in the stress level of the user in view of the user's usage data of various applications. For example, the processor may determine that the stress level of the user increases when the user spends more than 10 minutes on a social media application. In another example, the processor may determine that the stress level of the user decreases when the user uses an e-book application for more than 5 minutes. In other examples, the processor may choose to analyze the usage data of the user across multiple applications simultaneously.

As discussed above, the system 100 may be connected to other devices via VGA, HDMI, USB, Wi-Fi, Bluetooth, NFC over the local network or over the internet cloud. The other devices may be computing device, which includes one of various computing devices that have a keyboard/battery portion and a display screen portion. The computing devices may include, but not limited, to any one of various desktops, laptops, tablets, smart phones, watches and other similar devices. These devices may operate as a stationary computing device (e.g., personal computers (i.e., desktops), server computers, laptop computers (with permanently attached display screens), all in one devices, and other similar devices that possess comparable characteristics). In other implementations these devices can be handheld devices, such as tablets and smart phones.

In other implementation, there may be additional components that are not shown in FIG. 1. For example, the system 100 illustrated in FIG. 1 includes various engines to implement the functionalities described herein. The device 100 may have an operation engine, which handles an operating system, such as iOS®, Windows®, Android, and any other suitable operating system. The operating system can be multi-user, multiprocessing, multitasking, multithreading, and real-time. In one implementation, the operating system is stored in a memory (e.g., the memory 130 as shown in FIG. 1) performs various tasks related to the use and operation of the system 100. Such task may include installation and coordination of the various hardware components of the system 100, recognizing input from users, such as touch on the display screen, keeping track of files and directories on memory (e.g., the memory 130 as shown in FIG. 1) and managing traffic on bus (e.g., as shown in FIG. 1). Moreover, in another implementation, the system 100 may comprise a connection engine, which includes various components for establishing and maintaining device connections, such as computer-readable instructions for implementing communication protocols including TCP/IP, HTTP, Ethernet®, USB®, and FireWire®. The application engine may manage the operation of various applications in the device 100. should be noted that additional engines may be present in other implementations.

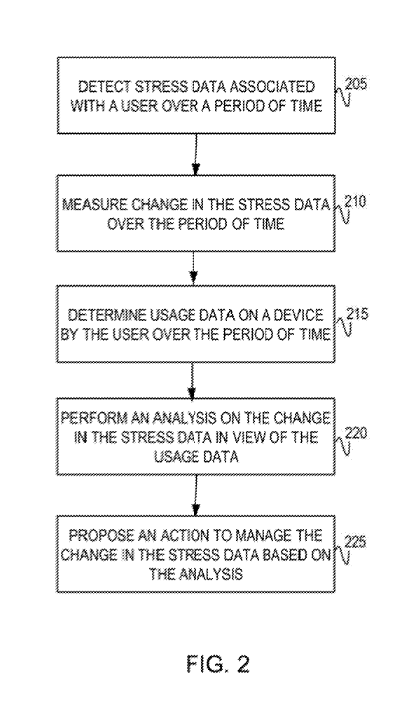

Turning now to the operation of the system 100, FIG. 2 illustrates a process flow diagram 200 in accordance with an example implementation. It should be readily apparent that the processes depicted in FIG. 2 represent generalized illustrations, and that other processes may be added or the illustrated processes may be removed, modified, or rearranged in many ways. Further, it should be understood that the processes may represent executable instructions stored on memory that may cause a processing device to respond, to perform actions, to change states, and/or to make decisions, for instance. Thus, the described processes may be implemented as executable instructions and/or operations provided by a memory associated with the system 100.

The illustrated process 200 may begin where a device comprising an audio unit captures audio data associated with a user (not shown in a block). More specifically, the audio unit captures the voice of the user continuously for a specific period of time, in another implementation, such data may be provided to the device. At block 205, the device detects stress data based on the audio data associated with the user. More specifically, the device identifies the change in the audio data over the specific period of time, and detects stress data based on the audio data. At block 210, the device measures the change in the stress level of the user over a predetermined period of time based on the change in the audio data. For example, the device determines the stress level at minute one considering the audio data in minute one. Moreover, the device determines the stress level at minute five given the audio data in minute five. Further, the device measures the change in the stress level by comparing the stress date at minute one and the stress data at minute five. At block 215, the device determines the user's usage data in applications on the device over the predetermined period of time. At block 220, the device performs an analysis of the change in the stress data in view of the user's usage data. More specifically, the device analyzes how the user's stress level varies as the user utilizes various applications over the predetermined period of time. Lastly, at block 225, the device proposes an action to the user in order to manage the stress data associated with the user. For example, if the device concludes that higher usage of social media application leads to higher stress level for the user, the device may propose to the user to limit the use of social media application in order to control the user's stress level.

While the above disclosure has been shown and described with reference to the foregoing examples, it should be understood that other forms, details, an implementations may be made without departing from the spirit cope of the disclosure that is defined in he following claims.

What is claimed is:

1. A mobile system, comprising:
an audio input device to continuously capture audio data associated with a user:
a display unit;
a processor, connected to the audio unit and the display unit, to:
detect stress data based on the audio data associated with the user over a period of time,
measure a change in the stress data over the period of time,
determine usage data on the mobile system by the user over the period of time,
perform an analysis of the change in the stress data in view of the usage data, and
propose an action to manage the change in the stress data based on the analysts.

2. The system of claim 1, wherein the stress data is presented to the user through a user interface on the display.

3. The system of claim 1, wherein the processor receives audio data associated with the user from the audio input device and applies voice stress analysis to analyze the audio data.

4. The system of claim 1, wherein the processor applies noise filtering to remove any noise in the audio data.

5. The system of claim 3, wherein the voice stress analysis comprises Hilbert-Huang Transform to decompose the audio data to detect the stress data and measure the change in the stress data,

6. The system of claim 1, further comprising a camera to continuously capture visual data of the user.

7. The system of claim 4, wherein the processor receives visual data from the camera to detect stress data associated with the user over the period of time and utilize the additional stress data in the combination.

8. The system of claim 1, wherein the stress data is related to at least one of psychological stress and physically stress.

9. The system of claim 1, wherein the system is connected to other systems via USB, VGA, HDMI, Bluetooth or Wi-Fi.

10. A processor-implemented method, comprising;
detecting stress data based on the audio data associated with the user over a period of time;
measuring a change in the stress data over the period of time;
determining usage data on the mobile system by the user over the period of time;
performing a combination of the change in the stress data with the usage data; and
proposing an action to manage the change in the stress data based on the combination.

11. The method of claim 10, wherein the usage data comprises data related to the user's active use of at least one application during the period of time.

12. The method of claim 10, wherein performing the combination of the change in the stress data with the usage data comprises identifying a correlation between the change in the stress data with the usage data.

13. The method of claim 12, wherein the change in the stress level is higher when the usage data is above a certain threshold.

14. The method of claim 10, wherein proposing an action comprises limiting use of the at least one application.

15. A non-transitory computer-readable medium comprising instructions which, when executed, cause a system to:
detect stress data based on the audio data associated with the user over a period of time;
measure a change in the stress data over the period of time;
determine usage data on the mobile system by the user over the period of time;
perform an analysis of the change in the stress data in view of the usage data; and
propose an action to manage the change in the stress data based on the analysis.
